(19) United States
(12) Patent Application Publication
(10) Pub. No.: US 2003/0043489 A1
(43) Pub. Date: Mar. 6, 2003

(54) Method and apparatus for providing instability recovery

(76) Inventors: Hae Jung Lee, Santa Clara, CA (US); Sang Lee, Pleasanton, CA (US); Keung Youn Cho, San Jose, CA (US)

Correspondence Address: IRELL & MANELLA LLP, 840 NEWPORT CENTER DRIVE, SUITE 400, NEWPORT BEACH, CA, 92660, US

(21) Appl. No.: 09/945,452

(22) Filed: Aug. 31, 2001

(51) Int. Cl. G11B 5/09; G11B 27/36

(52) U.S. Cl. 360/53; 360/31

(57) ABSTRACT

A method and system to optimize the performance of a read/write head in a hard disk drive. The method comprises providing a disk having at least one side with a plurality of tracks, selecting a current value, and applying the current value to the read/write head. The performance of the read/write head is then measured and the method determines if the current value has been applied to the read/write head a predetermined number of times. If not, the current value is applied to the read/write head a predetermined number of times. The best performance value of the read/write head and a corresponding current value are then stored.

### BACKGROUND OF THE INVENTION

1. Field of the Invention

The present invention relates in general to disk storage systems and more particularly, to methods and apparatus for providing instability recovery in read/write heads.

2. Description of the Related Art

Disk drives are magnetic recording devices used for the storage of information. The information is typically recorded on concentric tracks on either surface of one or more magnetic recording disks. The disks are rotatably mounted to a spin motor and information is accessed by means of read/write heads that are mounted to actuator arms which are rotated by a voice coil motor. The voice coil motor is excited with a current to rotate the actuator and move the heads. The read/write heads must be accurately aligned with the storage tracks on the disk to ensure proper reading and writing of information. The read/write heads read recorded information from the surface of the disk by sensing the magnetic transitions emanating from the surface of the disk. To write on a data track, current is applied to the read head. The current generates a magnetic field, which magnetizes the surface of the disk.

Instability of the magnetic recording head has been noted during read back of recorded patterns on the magnetic recording media. This is particularly noted when the read sensors used are magneto resistive (MR), giant magneto resistive (GMR) and tunneling magneto resistive (TMR). Instability occurs when the read back signal is unstable. With the signal base line moving up and down or providing abnormal signal peaks. The unstable state changes over time. However, it typically occurs after the write current is applied to the magnetic recording head.

Accordingly, there is a need in the technology for a method and apparatus for providing signal instability recovery in a hard disk drive assembly.

### BRIEF SUMMARY OF THE INVENTION

A method and system to optimize the performance of a read/write head in a hard disk drive. The method comprises providing a disk having at least one side with a plurality of tracks, selecting a current value, and applying the current value to the read/write head. The performance of the read/write head is then measured and the method determines if the current value has been applied to the read/write head a predetermined number of times. If not, the current value is applied to the read/write head a predetermined number of times. The best performance value of the read/write head and a corresponding current value are then stored.

### BRIEF DESCRIPTION OF THE DRAWINGS

FIG. 1 illustrates a hard disk drive which utilizes the methods of the invention.

FIG. 2 illustrates the general layout of the servo field region of a track.

FIG. 3 is a block diagram of portions of an integrated circuit read channel in accordance with the present invention.

FIGS. 4A and B are flow charts that illustrate one embodiment of the instability recovery process provided in accordance with the principles of the invention.

FIGS. 5A-5C are flow charts that illustrate an alternate embodiment of the instability recovery process provided in accordance with the principles of the invention.

### DETAILED DESCRIPTION OF THE INVENTION

The present invention is an apparatus and methods for providing signal instability recovery in a hard disk drive assembly.

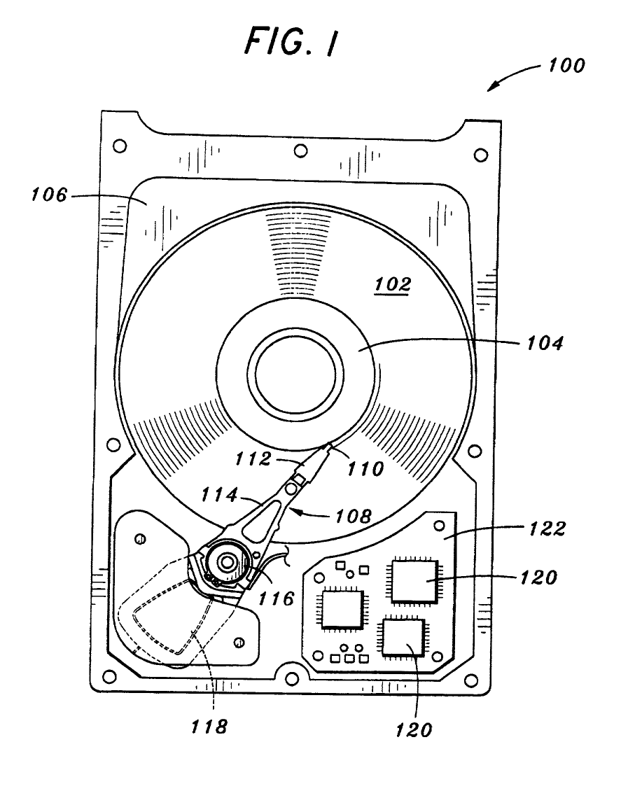

Referring to the drawings more particularly by reference numbers, FIG. 1 shows a hard disk drive 100. The disk drive 100 includes a disk 102 that is rotated by a spin motor 104. The spin motor 104 is mounted to a base plate 106. Also mounted to the base plate 106 is an actuator arm assembly 108. The actuator arm assembly 108 includes a number of heads 110 mounted to corresponding flexure arms 112. The flexure arms 112 are attached to an actuator arm 114 that can rotate about a bearing assembly 116. The assembly 108 also contains a voice coil 118 that is coupled to magnets 119 that are mounted to the base plate 106. Energizing the voice coil 118 moves the heads 110 relative to the disk 102. There is typically a single head for each disk surface. The spin motor 104, voice coil 118 and the heads 110 are coupled to a number of electronic circuits 120 mounted to a printed circuit board 122. In the following discussion, only one head 110 is referenced. The electronic circuits 120 typically include a read channel circuit, a microprocessor-based controller and a random access memory (RAM) device.

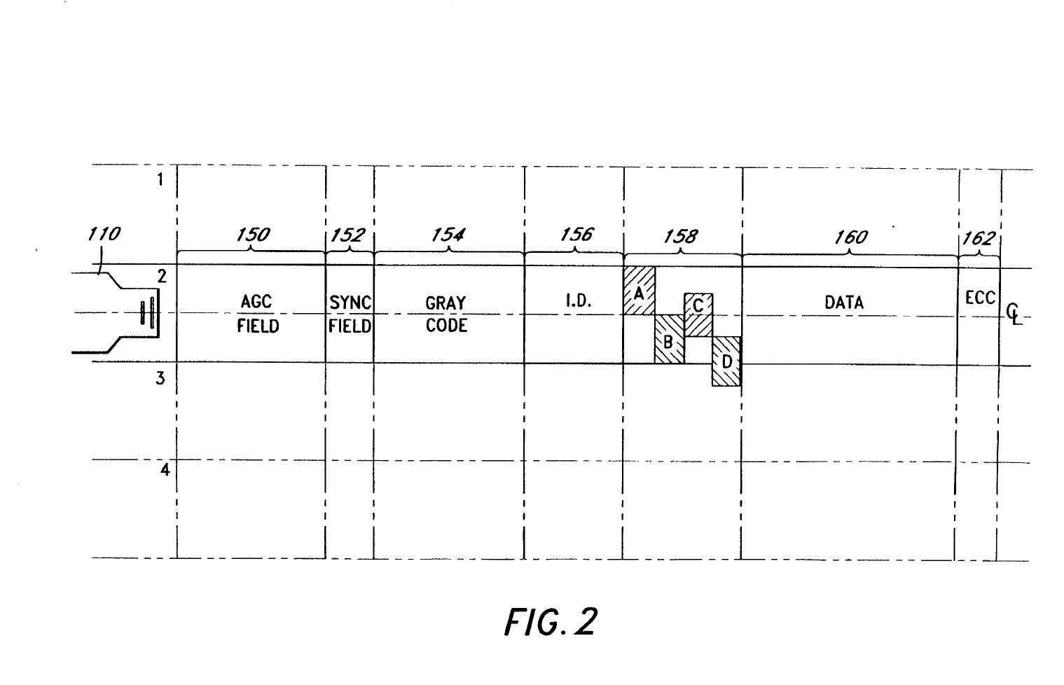

As shown in FIG. 2, data is typically stored within sectors of radially concentric tracks located across the disk 102. A typical sector will have an automatic gain control (AGC) field 150, a synchronization (sync) field 152, a gray code field 154 that identifies the track, an identification (ID) field 156 that defines the sector, a servo field 158 which includes a number of servo bits A, B, C, D, a data field 160 which contains the data and an error correction code field 162. In operation, the head 110 is moved to a track and the servo information provided in servo field 158 is read and provided to the electronic circuits 120. The electronic circuits 120 utilize the variation in the servo bits (A-B) or (C-D) to generate X_{O}, a positioning signal for aligning the head 110.

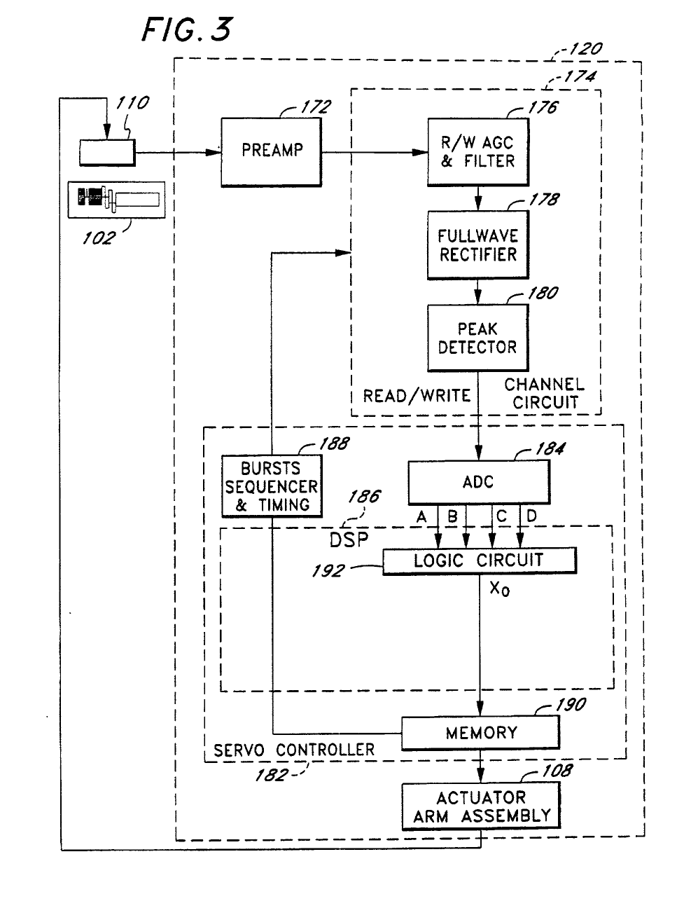

FIG. 3 is a block diagram of an electronic circuit 120 of the drive. The electronic circuit 120 includes a preamplifier 172 which is coupled to a read/write (R/W) channel circuit 174. The R/W channel circuit 174 includes a R/W Automatic Gain Control (AGC), and filter circuit 176, a fullwave rectifier 178 and a peak detector 180. The electronic circuit 120 further comprises a microprocessor-based servo controller 182 which includes an analog-to-digital converter (ADC) 184, a digital signal processor (DSP) 186, a burst sequencer and timing circuit 188 and a memory 190, such as a random access memory (RAM) device. The DSP 186 includes a logic circuit 192.

The electronic circuit 120 is coupled to one of the magnetic heads 110 which senses the magnetic field of a magnetic disk 102. When reading the servo information located in the servo field region 158 on the disk 102, the head 110 generates a read signal that corresponds to the magnetic field of the disk 102. The read signal is first amplified by the preamplifier 172, and then provided to the R/W channel circuit 174. The AGC data included in the read signal is provided to the R/W AGC and filter circuit 176. The R/W AGC circuit in circuit 176 monitors the AGC data provided by the read signal and the read signal is then filtered by the filter circuit located in the R/W AGC and filter circuit 176. The fullwave rectifier 178 rectifies the read signal and provides the rectified read signal to the peak detector 180. The peak detector 180 detects the amplitude of the read signal. The read signal is then provided to the ADC 184 which provides digitized samples of the analog read signal. The digitized signal is then provided to a logic circuit 192 located within the DSP 186. The logic circuit 192 generates a position signal X_{O}, based on the servo bits A, B, C and D that are read by the head 110. The position signal X_{O} is stored in memory 190, and subsequently provided to the actuator arm assembly 108 to move the heads 110. Alternatively, the position signal X_{O} can be provided directly to the actuator arm assembly 108 to move the heads 110.

The present invention is an apparatus and method for providing signal instability recovery. In particular, the inventor facilitates recovery of the read sensor from an unstable state to a stable or normal state. In one embodiment, a bias current of 10 to 200% of the normal operating bias current is applied to the read sensor for a short interval. In one embodiment, the interval lasts from 1 nanosecond to 1 millisecond, and the direction of the current is the same as the normal bias current.

The recovery process may occur during manufacturing of the hard disk drive and/or by the user during the user recovery process. In general, the head is first examined to determine if it is unstable. This may be done through an examination of the bit error rate or channel quality measurement. If the head is stable, the recovery process may be bypassed and the normal hard disk drive routines or normal use may proceed. If the head performance is below a predetermined criteria, the signal instability recovery process may be applied.

During manufacturing, the resistance of the read sensor is first measured. Based on the resistance, the range and duration of the high current bias application are determined. A bias current value is selected from the range determined. The bias current is applied to the read/write head for the selected duration of time. The read/write head performance is then measured. The performance may be determined by checking the error rate of the signal or the read channel quality. In addition, the performance may be measured a predetermined number of times, e.g., 20 times. The best performance among the performances measured is determined and used as a threshold criteria, T. The bias current may be applied once again to the read/write head and its performance is measured again. If the measured head performance is better than T, the performance characteristics (bias current value, duration and performance measurements and the corresponding read/write head) are recorded and the routine is terminated. The recorded data may be used later for stability the same read/write head.

During the user recovery process, a similar technique may be applied to stabilize a read/write head. If there is an error during use of the hard disk drive, the system first checks if the error is due to a defect from the hard disk or if it is due to poor read/write head performance. If the error is due to a hard disk defect, the system transfers control from the instability recovery process. If the error is determined to be due to poor read/write head performance, the system executes the recovery process described earlier to stabilize the read/write head.

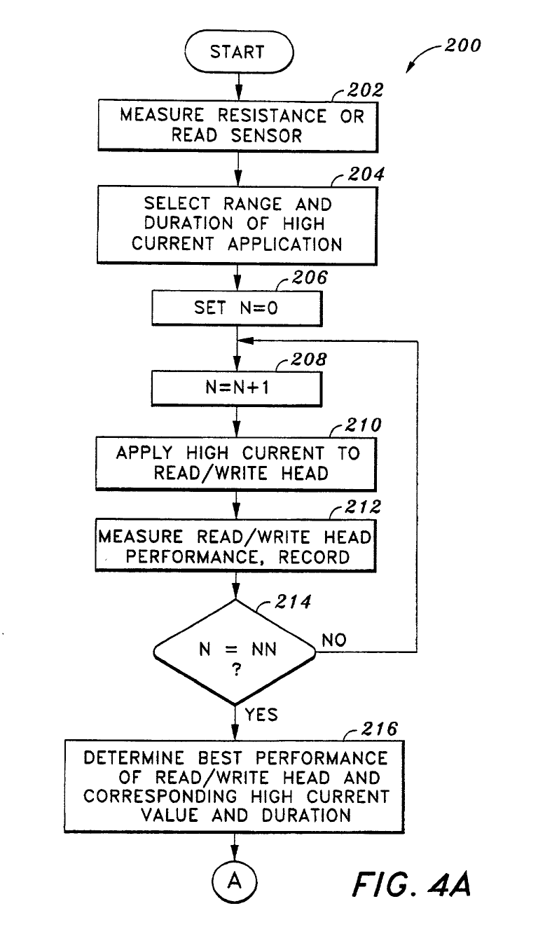

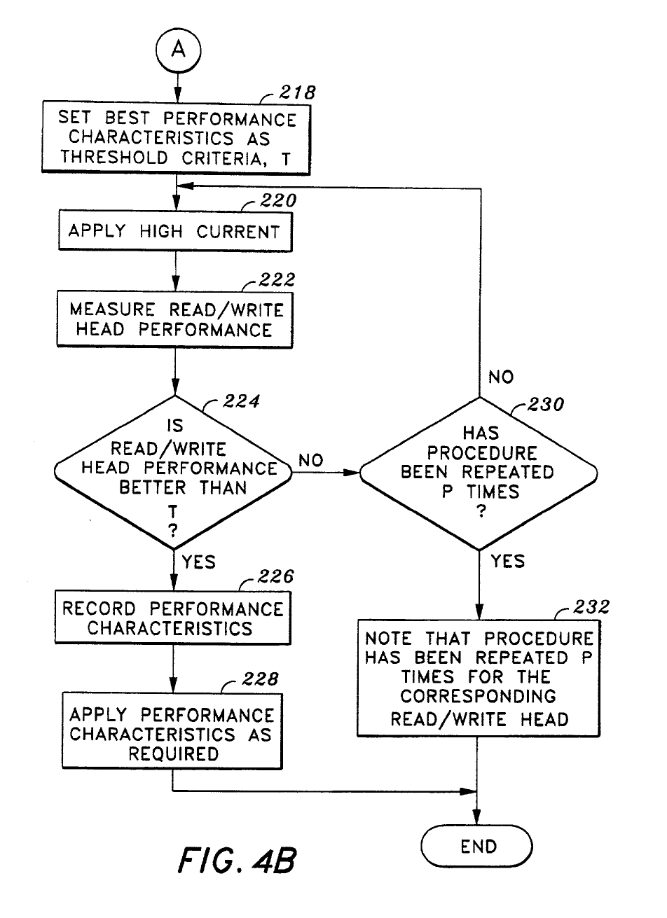

FIGS. 4A and 4B are flow charts that illustrate one embodiment of the instability recovery process provided in accordance with the principles of the invention. In one embodiment, the process 200 occurs during the disk drive manufacturing process. Proceeding from a START state, the process 200 proceeds to process block 202, where it measures the resistance of a read sensor in the read/write head. Next, the process 200 selects the range of current values and duration of the high current application (process block 204). Then, a counter, N is first initialized to zero (process block 206). The counter then proceeds to count based on the expression N=N+1 (process block 208). The process 200 then applies high current to the read/write head (process block 210). The performance of the read/write head is then measured and recorded (process block 212). In one embodiment, the performance of the read/write head may be determined by first writing and then reading the written data to ensure that the written data is read correctly. One criteria is to use a predetermined error rate as a threshold for performance evaluation. In an alternate embodiment, the quality of the read signal is used to gauge performance. In a further embodiment, the performance of the read/write head is measured after data has been written a predetermined number of times to one or more tracks. The written data is read a predetermined number of times to evaluate performance of the read/write head. Such a process may be conducted as follows.

At decision block 214, the process 200 queries if the writing/reading process has been performed a predetermined number of times, NN. If not, the process 200 returns to process block 208. Otherwise, it proceeds to process block 216, where it determines the best performance of the read/write head, and the corresponding high current value and duration of high current application used. These values may be recorded as the best performance characteristics associated with the read/write head.

Next, the best performance characteristics are used as a threshold criteria, T (process block 218). High current is again applied to the read/write head (process block 220). The read/write head performance is measured following the application of high current (process block 222). The process 200 then determines if the read/write head performance is better than T (decision block 224). If so, it records the performance characteristics of the read/write head (process block 226). The performance characteristics are stored and applied as required (process block 228). The process 200 then terminates.

If, at decision block 224, the process 200 determines that the read/write head performance is not better than T, the process proceeds to decision block 230, where it determines if the high current application procedure has been repeated a predetermined number of times, P. If not, the process returns to process block 220. Otherwise, it notes that the procedure has been repeated P times for the corresponding read/write head (process block 232) and then terminates.

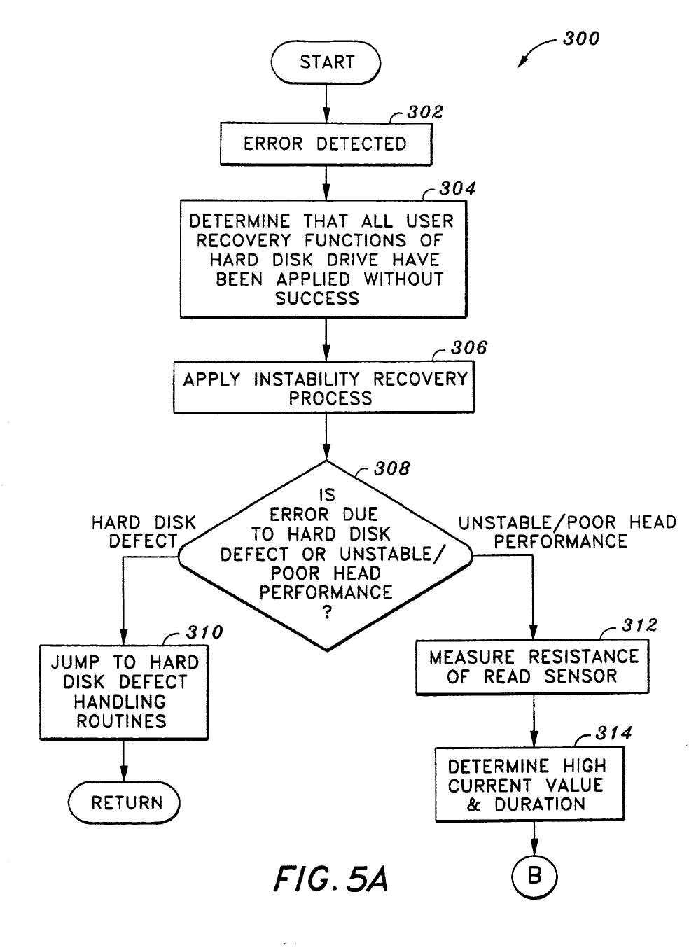

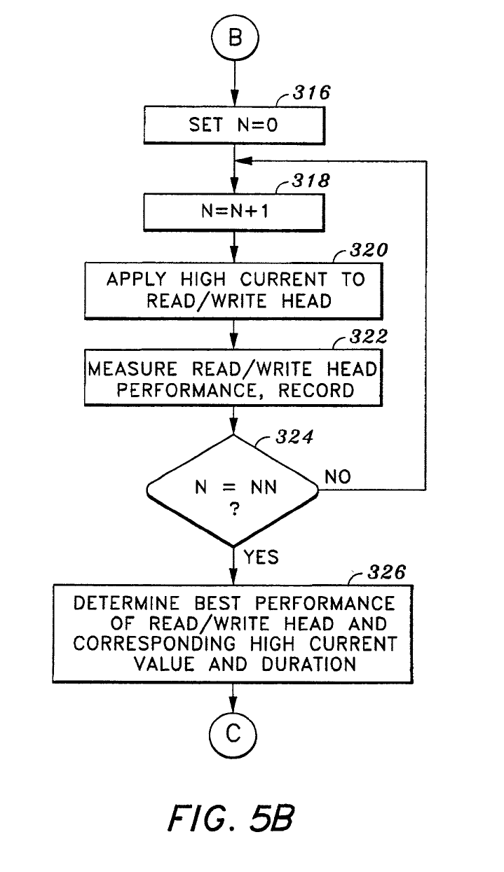

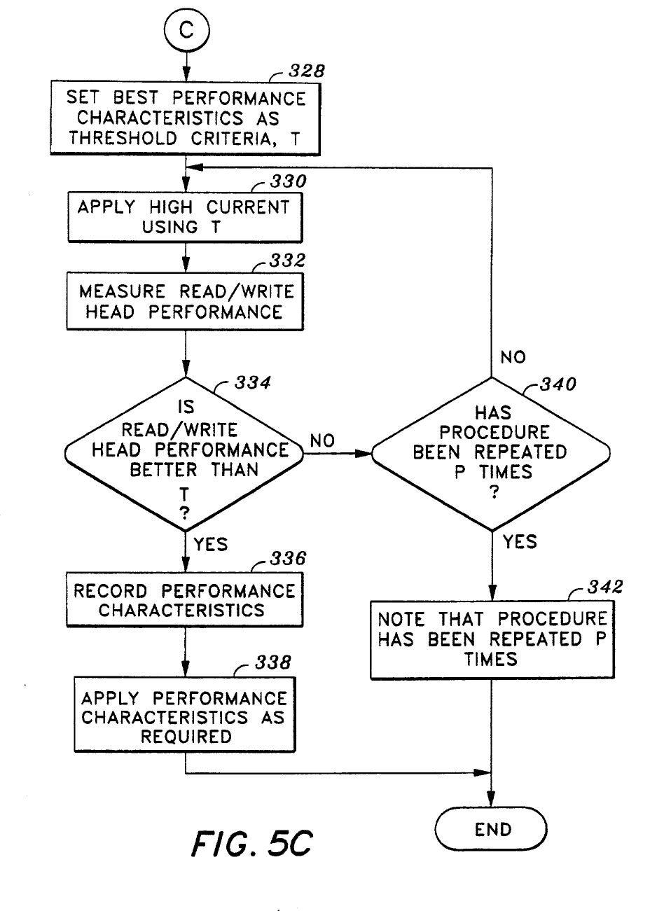

FIGS. 5A-5C are flow charts that illustrate an alternate embodiment of the instability recovery process provided in accordance with the principles of the invention. In one embodiment, the process 300 occurs during the user application process. Proceeding from a START state, the process 300 first detects an error (process block 302). It then determines that all user recovery functions of the hard disk drive have been applied without success (process block 304). The process 300 then applies the instability recovery process to the read/write head (process block 306). This begins with a query as to whether the error is due to a hard disk defect or an unstable/poor head performance (decision block 308). If the error is due to a hard disk defect, the process 300 jumps to the hard disk defect handling routines and returns to the main operating process. If the error is due to an unstable head or due to poor head performance, the process 300 proceeds to measure the resistance of the read sensor (process block 312). The process 300 then determines the corresponding high current value and high current application duration that should be used (process block 314).

Next, a counter, N is first initialized to zero (process block 316). The counter then proceeds to count based on the expression N=N+1 (process block 318). The process 200 then applies high current to the read/write head (process block 320). The performance of the read/write head is then measured and recorded (process block 322). In one embodiment, the performance of the read/write head may be determined by first writing and then reading the written data to ensure that the written data is read correctly. One criteria is to use a predetermined error rate as a threshold for performance evaluation. In an alternate embodiment, the quality of the read signal is used to gauge performance. In a further embodiment, the performance of the read/write head is measured after data has been written a predetermined number of times to one or more tracks. The written data is read a predetermined number of times to evaluate performance of the read/write head. Such a process may be conducted as follows.

At decision block 324, the process 300 queries if the writing/reading process has been performed a predetermined number of times, NN. If not, the process 300 returns to process block 318. Otherwise, it proceeds to process block 326, where it determines the best performance of the read/write head, and the corresponding high current value and duration of high current application used. These values may be recorded as the best performance characteristics associated with the read/write head.

Next, the best performance characteristics are used as a threshold criteria, T (process block 328). High current is again applied to the read/write head (process block 330). The read/write head performance is measured following the application of high current (process block 332). The process 300 then determines if the read/write head performance is better than T (decision block 334). If so, it records the performance characteristics of the read/write head (process block 336). The performance characteristics are stored and applied as required (process block 338). The process 300 then terminates.

If, at decision block 334, the process 300 determines that the read/write head performance is not better than T, the process proceeds to decision block 330, where it determines if the high current application procedure has been repeated a predetermined number of times, P. If not, the process returns to process block 330. Otherwise, it notes that the procedure has been repeated P times for the corresponding read/write head (process block 342) and then terminates.

While certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art.

What is claimed:

1. A method to optimize the performance of a read/write head in a hard disk drive, comprising:
a) providing a disk having at least one side with a plurality of tracks;
b) selecting a current value;
c) applying said current value to said read/write head;
d) measure a performance of said read/write head;
e) determine if c) and d) has been performed a predetermined number of times, if not, repeating c) through e);
f) if c) and d) has been performed a predetermined number of times, determine a best performance value of said read/write head and a corresponding current value.

2. The method as recited in claim 1, further comprising:
g) setting said best performance value as a criteria;
h) applying said current value to said read/write head;
i) measuring a second performance value of said read/write head.

3. The method as recited in claim 2, further comprising:
j) determining if said second performance value is better than said criteria, if so, storing said second performance value as a current application value, along with said corresponding second performance value.

4. The method as recited in claim 3, wherein if said second performance value is not better than said criteria, said method further comprising:
k) determining if acts h) through j) have been repeated a predetermined number of times, if not, repeating acts h) through j);
l) if acts h) through j) has been repeated a predetermined number of times, storing a message indicating that acts h) through j) has been repeated a predetermined number of times.

5. The method as recited in claim 1, wherein said performance value is determined by writing data onto the selected track, reading the written data, and determining a number of errors on said track.

6. The method as recited in claim 1, further comprising, prior to a), measuring a resistance of a read sensor of said read/write head.

7. The method as recited in claim 5, wherein in b) said current value is selected from a range corresponding to said resistance of said read sensor.

8. The method as recited in claim 7, wherein said current value comprises a magnitude of a current and a duration of applying said current.

9. The method as recited in claim 1, further comprising, prior to a):
i) detecting an error;
ii) determining that all user recovery functions of the hard disk drive have been applied without success.

10. The method as recited in claim 9, further comprising:
iii) determining if the error is due to hard disk defect or unstable read/write head performance;
iv) if the error is due to hard disk defect, then turning processing control to disk defect handling routines, otherwise proceeding to a).

11. A system to optimize a write channel in a hard disk drive, comprising:
a housing;
a spin motor mounted to said housing;
an actuator arm mounted to said spin motor; a disk attached to said spin motor, said disk having at least one side with a plurality of tracks;
a memory to store instruction sequences;
a processor coupled to said memory;
a read/write head mounted to said actuator arm to write on and read from said at least one side of said disk, said read/write head coupled to said processor, wherein said processor executes said instruction sequences to:
a) provide a disk having a at least one side with a plurality of tracks;
b) select a current value;
c) apply said current value to said read/write head;
d) measure a performance of said read/write head;
e) determine if c) and d) has been performed a predetermined number of times, if not, repeating c) through e);
f) if c) and d) has been performed a predetermined number of times, determine the best performance value of said read/write head and a corresponding current value.

12. The system as recited in claim 11, wherein said instruction sequences further causes said processor to:
g) set said best performance value as a criteria;
h) apply said current value to said read/write head;
i) measure a second performance value of said read/write head.

13. The system as recited in claim 12, wherein said instruction sequences further cause said processor to:
j) determine if said second performance value is better than said criteria, if so, storing said second performance value as a current application value, along with said corresponding second performance value.

14. The system as recited in claim 13, wherein if said second performance value is not better than said criteria, said method further comprising:
k) determining if acts h) through j) have been repeated a predetermined number of times, if not, repeating acts h) through j);
l) if acts h) through j) has been repeated a predetermined number of times, storing a message indicating that acts h) through j) has been repeated a predetermined number of times.

15. The system as recited in claim 11, wherein in d), said wherein said performance value is determined by writing data onto the selected track, reading the written data, and determining a number of errors on said track.

16. The system as recited in claim 11, wherein said instruction sequences further cause said processor to, prior to a), measure a resistance of a read sensor of said read/write head.

17. The system as recited in claim 16, wherein in b) said current value is selected from a range corresponding to said resistance of said read sensor.

18. The system as recited in claim 17, wherein said current value comprises a magnitude of a current and a duration of applying said current.

19. The system as recited in claim 11, wherein said instruction sequences further cause said processor to, prior to a):
i) detect an error;
ii) determine that all user recovery functions of the hard disk drive have been applied without success.

20. The system as recited in claim 19, wherein said instruction sequences further cause said processor to:
iii) determining if the error is due to hard disk defect or unstable read/write head performance;
iv) if the error is due to hard disk defect, then turning processing control to disk defect handling routines, otherwise proceeding to a).
